(19) United States
(12) Patent Application Publication
(10) Pub. No.: US 2025/0138995 A1
(43) Pub. Date: May 1, 2025

(54) OPTIMIZING DATA TRANSFERS BETWEEN A PARALLEL PROCESSING PROCESSOR AND A MEMORY

(71) Applicant: COMMISSARIAT A L'ENERGIE ATOMIQUE ET AUX ENERGIES ALTERNATIVES, Paris (FR)

(72) Inventors: Benoit TAIN, Gif-Sur-Yvette Cedex (FR); Raphaël MILLET, Gif-Sur-Yvette Cedex (FR)

(73) Assignee: COMMISSARIAT A L'ENERGIE ATOMIQUE ET AUX ENERGIES ALTERNATIVES, Paris (FR)

(21) Appl. No.: 18/911,459

(22) Filed: Oct. 10, 2024

(30) Foreign Application Priority Data
Oct. 27, 2023 (FR) 2311716

(51) Int. Cl. G06F 12/02

(52) U.S. Cl. CPC G06F 12/0223

(57) ABSTRACT

Computing system comprising a memory A, a memory access control module, and a parallel processing processor comprising a plurality of computing units each comprising a memory B shared by one or more elementary processors. The computing units are arranged in columns. A partition of the memory A is associated with each column. Connection modules are connected respectively to the partitions of the memory A and to the memories B of the computing units. Within a column, the neighboring connection modules are connected to one another by a dedicated interface link. The memory access control module is adapted to configure the connection modules to execute parallel data transfers in a plurality of columns, each transfer making it possible to exchange data within a column between a partition of the memory A and a memory B of at least one computing unit.

### TECHNICAL FIELD

The present invention belongs to the field of computing systems comprising a parallel processing processor acting as a hardware accelerator. The invention particularly relates to a particular architecture for such a computing system aiming to optimize data transfers between the parallel processing processor and a memory external to said processor.

### BACKGROUND

In the field of artificial intelligence, and more particularly in the context of deep neural networks, the issue of data movements is of major importance. Deep neural networks are machine learning models that require a considerable volume of data in order to carry out complex tasks such as the recognition of images, the detection of objects, or the detection of anomalies.

Data movement refers to the handling and transfer of these data from one memory location to another. This poses a certain number of challenges in the context of deep neural networks. The massive volume of data used by these models requires suitable processing and storage resources in order to effectively manage the movement operations. The data must be transferred quickly and reliably in order to minimize the waiting times and optimize the performance of the neural network.

The problem of moving data in embedded systems has additional challenges. Indeed, embedded systems, such as Internet of Things (IoT) devices, autonomous vehicles or drones, are characterized by their limited resources in terms of computing power, memory and energy. In this context, the effective movement of data becomes crucial in order to guarantee optimal performance and an effective use of the resources. Another important challenge is the management of energy in the embedded systems. As energy resources are limited, it is crucial to minimize the energy consumption during data movement.

FIG. 1 schematically shows a conventional computing system 10 making it possible to process a significant amount of data at the same time. Such a computing system 10 may particularly be used to implement an algorithm based on a deep neural network.

As illustrated in FIG. 1, the computing system 10 comprises a host processor 11, a parallel processing processor 15, a memory 12 (memory A, or “Mem A”), an interconnection bus 13, and a memory access control module 14.

The host processor 11 corresponds to a central processing unit (CPU). The host processor 11 manages the general execution of the system, including the communication with the parallel processing processor 15. The parallel processing processor 15 acts as a hardware accelerator; this is a component designed specifically to carry out intensive computing operations for machine learning algorithms. The parallel processing processor 15 comprises a plurality of computing units 16 (UC). Each computing unit 16 comprises one or more elementary processors and a memory (memory B or Mem B) shared by the elementary processors.

In the case of embedded systems, the memory A may correspond to the main memory of the system. This memory is generally qualified as a level 2 memory (L2 memory). The memories B of computing units distributed in the parallel processing processor are then generally qualified as level 1 memories (L1 memory).

The interconnection bus 13 makes it possible to carry out data exchanges between the host processor 11, the memory 12 and the parallel processing processor 15, and also possibly with other components of the system.

The memory access control module 14 (also referred to as DMA, for “Direct Memory Access”) makes it possible to transfer data between the parallel processing processor 15 (or possibly another component of the system) and the memory 12 without direct intervention of the host processor 11.

The DMA is a key element, because it makes it possible to use as best as possible the throughput of the interconnection bus. In a conventional system, when an external peripheral desires to transfer data to the memory A, or coming therefrom, this generally requires the intervention of the host processor. The host processor must read or write the data sequentially, and this may create a bottleneck and ineffective use of the host processor and of the interconnection bus.

The DMA makes it possible to circumvent this limitation by offering a direct route for the data transfers between the peripherals and the memory A without passing through the host processor at each step. The DMA generally embeds a dedicated controller that takes care of the transfer operations.

When a peripheral desires to transfer data, it sends a request to the DMA. The latter subsequently accesses the memory A via the interconnection bus and carries out the requested data transfer between the peripheral and the memory A, without needing an intervention of the host processor. Once the transfer has finished, the DMA can generate an interrupt to inform the host processor of the end of the operation.

Using the DMA has a plurality of advantages. First of all, it reduces the work load of the host processor. The host processor may thus dedicate itself to other critical tasks. In addition, data transfers via DMA are generally quicker than those carried out by the host processor. This improves the overall performance of the system. Finally, the DMA makes it possible to manage the memory A more effectively, by preventing the blockages and by optimizing the data transfers between the peripherals and the memory A.

However, in spite of all these advantages, the maximum achievable theoretical throughput remains directly related to the width of the interconnection bus. The maximum throughput is in the best case scenario equal to the width of the interconnection bus multiplied by the operating frequency of the system. Conventionally, the memory A of the computing system 10 illustrated in FIG. 1 is a unified memory, with a single access interface connected to the interconnection bus. This creates a bottleneck at the access to the memory A, and a limitation of the throughput for the data transfers between the memory A and the memories B distributed within the parallel processing processor 15. In particular, when data must be transferred from a plurality of memories B to the memory A, the DMA will need to sequentially launch a series of transfers from each memory B, one after the other, to the memory A.

### SUMMARY

The object of the present invention is to remedy all or part of the drawbacks of the prior art.

To this end, and according to a first aspect, the present invention proposes a computing system comprising a memory, referred to as “memory A”, a memory access control module, and a parallel processing processor comprising a plurality of computing units. Each computing unit comprises one or more elementary processors and a memory, referred to as “memory B”, shared by said elementary processors. The computing units of the parallel processing processor are arranged into a plurality of columns and, in each column, the computing units are ordered from a first computing unit to a last computing unit, with zero, one or more intermediate computing units between the first computing unit and the last computing unit. The first computing unit corresponds to the last computing unit when the column comprises only one computing unit.

The memory A is partitioned so as to associate a partition of the memory A with each column of computing units and, for each column, the computing system comprises connection modules ordered from a first connection module connected to the partition of the memory A, to a last connection module connected to the memory B of the last computing unit, with zero, one or more intermediate connection modules between the first connection module and the last connection module, each intermediate connection module being connected to the memory B of a computing unit.

The first connection module has a dedicated interface link with the next connection module, each intermediate connection module has a dedicated interface link on the one hand with the previous connection module and on the other hand with the next connection module, the last connection module has a dedicated interface link with the previous connection module.

The memory access control module is adapted to configure the connection modules to carry out a first data transfer, for a first column, between the partition of the memory A associated with said first column and a memory B of at least one computing unit of said first column and, simultaneously with the first transfer, to carry out at least one second data transfer, for a second column, between the partition of the memory A associated with said second column and a memory B of at least one computing unit of said second column.

The first data transfer and the second data transfer are carried out via dedicated interface links connecting the connection modules with one another.

Thus, the invention is based on a division of the memory A into a plurality of partitions having a column arrangement similar to that of the memories B embedded in the parallel processing processor (“column symmetry” between the partitions of the memory A and the distributed memories B). The data transfers may take place at the same time in various columns via the connection modules.

The partitioning of the memory A indeed makes it possible to multiply the access interfaces to the various partitions and gives the opportunity to transfer at the same time with the distributed memories B. The transfer rate is thus multiplied by the number of columns defined in the arrangement chosen.

In particular embodiments, the invention may further include one or more of the following features, taken alone or according to any technically possible combinations.

In particular embodiments, the first data transfer makes it possible to transfer data from the partition of the memory A associated with the first column to the memories B of a plurality of various computing units of the first column, by passing at most once through the connection module of each computing unit of the first column.

Such provisions make it possible to broadcast data from a partition of the memory A to the memories B of a plurality of computing units of the column associated with the partition, with a single transfer coming from the memory A.

In particular embodiments, the memory access control module is adapted to configure the connection modules to carry out a data transfer, for at least one column, from a memory B of a computing unit of said column to a memory B of at least one other computing unit of said column.

The connection modules may thus also make it possible to transfer data between the memories B of various computing units of the same column (without necessarily involving the memory A).

In particular embodiments, the memory access control module is adapted to configure the connection modules to carry out simultaneous data transfers involving a plurality of columns with, for each column involved, a data transfer from a region of the partition located at a local source address identical for all the columns involved, to a region of a memory B of at least one computing unit, said region being located at a local destination address identical for all the columns involved.

In particular embodiments, the memory access control module is adapted to configure the connection modules to carry out simultaneous data transfers involving a plurality of columns with, for each column involved, a data transfer from a region of a memory B of a computing unit, said region being located at a local source address identical for all the columns involved, to a region of the partition located at a local destination address identical for all the columns involved.

In other terms, the connection modules of the same row may be configured in the same way to make similar data transfers (with the same local source address and the same local destination address) parallel in various columns.

In particular embodiments, each intermediate connection module comprises an upper routing block and a lower routing block. The upper routing block can be configured in the following modes:
“Read”: for reading data in the memory B to which the intermediate connection module is connected and transmitting the data read to the previous connection module, or
“Write”: for receiving data from the previous connection module and writing the data received in the memory B to which the intermediate connection module is connected, or
“Default”: for receiving data from the previous connection module and transferring the data received to the lower routing block of the intermediate connection module,
   The lower routing block can be configured in the following modes:
“Read”: for reading data in the memory B to which the intermediate connection module is connected and transmitting the data read to the next connection module, or
“Write”: for receiving data from the next connection module and writing the data received in the memory B to which the intermediate connection module is connected, or
“Default”: for receiving data from the next connection module and transferring the data received to the upper routing block of the intermediate connection module.

In particular embodiments, the first connection module comprises a lower routing block that can be configured in the following modes:
“Read”: for reading data in the memory A and transmitting the data read to the next connection module,
“Write”: for receiving data from the next connection module and writing the data received in the memory A;
   The last connection module comprises an upper routing block that can be configured in the following modes:
“Read”: for reading data in the memory B of the last connection module and transmitting the data read to the previous connection module,
“Write”: for receiving data from the previous connection module and writing the data received in the memory B of the last connection module.

In particular embodiments, the memory access control module comprises at least two control modules, each control module being adapted to configure identically all the connection modules having the same order rank in the various columns.

In particular embodiments, the connection modules are all implemented identically, and the control modules are all implemented identically.

In particular embodiments, the computing system comprises a host processor and an interconnection bus, and the memory A comprises program code instructions for configuring the host processor. The partitions of the memory A are defined with a contiguous address mapping such that the program code instructions are stored in a region of the memory A distinct from the partitions.

By defining a contiguous address mapping at the partitions of the memory A, the possibility of an overall access to the memory A via the interconnection bus is kept, as if it were unified.

In particular embodiments, the computing system comprises a host processor and an interconnection bus. The host processor is adapted to configure the memory access control module for exchanging data with the memory A or with a memory B of at least one computing unit of the parallel processing processor, by passing through the interconnection bus, without passing through a dedicated interface link connecting two neighboring connection modules. Each connection module comprises an arbitration module for managing an access priority to the memory to which the connection module is connected, between:
a “dedicated” transfer involving a neighboring connection module, and
a “bus” transfer involving the interconnection bus.

Such provisions make it possible to manage the coexistence of “dedicated” transfers (transfers carried out via the connection modules, without involving the interconnection bus) and of “bus” transfers (transfers carried out via the interconnection bus, without involving the interface links connecting the connection modules with one another).

### BRIEF DESCRIPTION OF THE DRAWINGS

The invention will be better understood upon reading the following description, given by way of non-limiting example, and referring to FIGS. 1 to 20 that show:

FIG. 1 a schematic representation of a conventional computing system,

FIG. 2 a schematic representation of a computing system according to the invention,

FIG. 3 a schematic representation of a computing unit of the parallel processing processor of the computing system of FIG. 2,

FIG. 4 an illustration (first portion) of a data transfer from the distributed memories of the parallel processing processor to the memory A of the computing system,

FIG. 5 an illustration (second portion) of a data transfer from the distributed memories B of the parallel processing processor to the memory A of the computing system,

FIG. 6 one example of memory address mapping of the memory A of the computing system 20 (example with forty-eight computing units arranged in eight columns and six rows),

FIG. 7 a schematic representation of a connection module,

FIG. 8 another schematic representation of a connection module,

FIG. 9 another schematic representation of a connection module,

FIG. 10 a schematic representation of the memory access control module,

FIG. 11 an illustration of the configuration of the various connection modules by the modules for controlling the memory access control module,

FIG. 12 a schematic representation of fields forming a source address or a destination address,

FIG. 13 a schematic representation of a module for controlling the memory access control module,

FIG. 14 a schematic representation of a routing module according to a first embodiment,

FIG. 15 a schematic representation of an upper or lower routing block according to a second embodiment,

FIG. 16 a schematic representation of an intermediate connection module according to the second embodiment,

FIG. 17 a schematic representation of a connection module at the top of the column according to the second embodiment,

FIG. 18 a schematic representation of a connection module at the bottom of the column according to the second embodiment,

FIG. 19 a schematic representation of a control module to configure a connection module at the top and at the bottom of the column according to the second embodiment,

FIG. 20 an illustration of the configuration of three connection modules of a column according to the second embodiment.

In these figures, identical references from one figure to another designate identical or similar elements. For reasons of clarity, the elements shown are not necessarily to the same scale, unless otherwise specified.

### DETAILED DESCRIPTION OF EMBODIMENTS

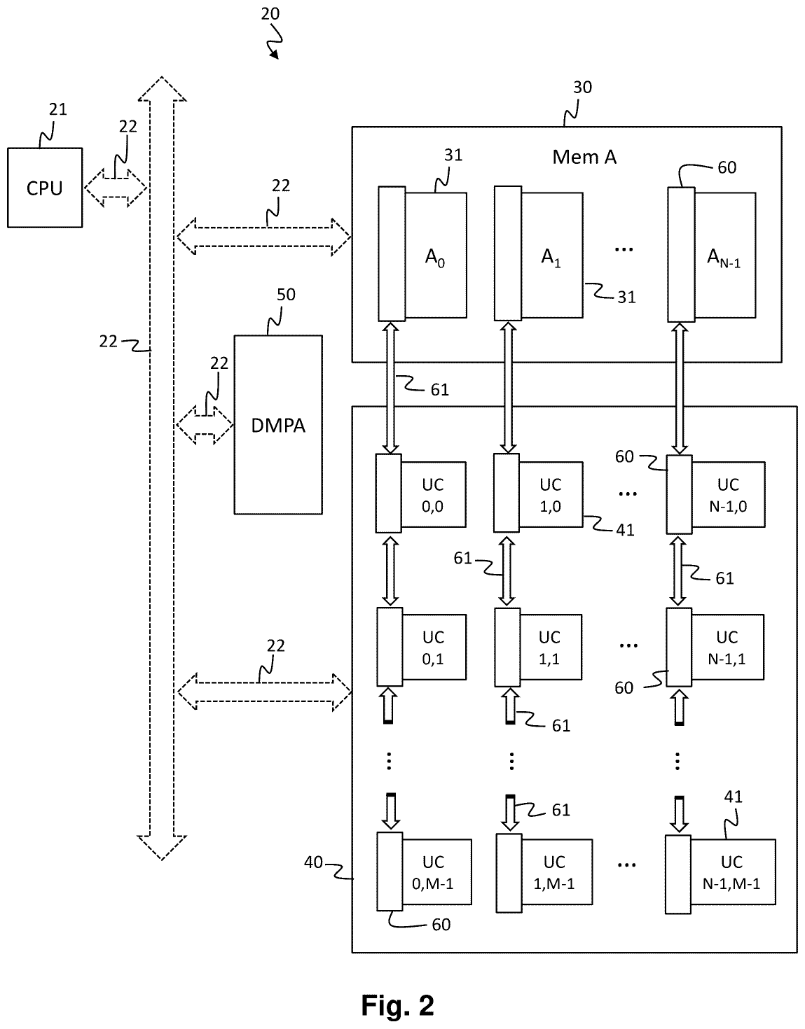

FIG. 2 shows one example of embodiment of a computing system 20 according to the invention. By way of non-limiting example, it relates to the case of an embedded computing system 20 making it possible to execute an artificial intelligence process (for example a machine learning algorithm) requiring the processing of a large amount of data. This may concern for example an algorithm based on a deep neural network for carrying out image processing tasks (recognition of images, detection of objects, detection of anomalies, etc.).

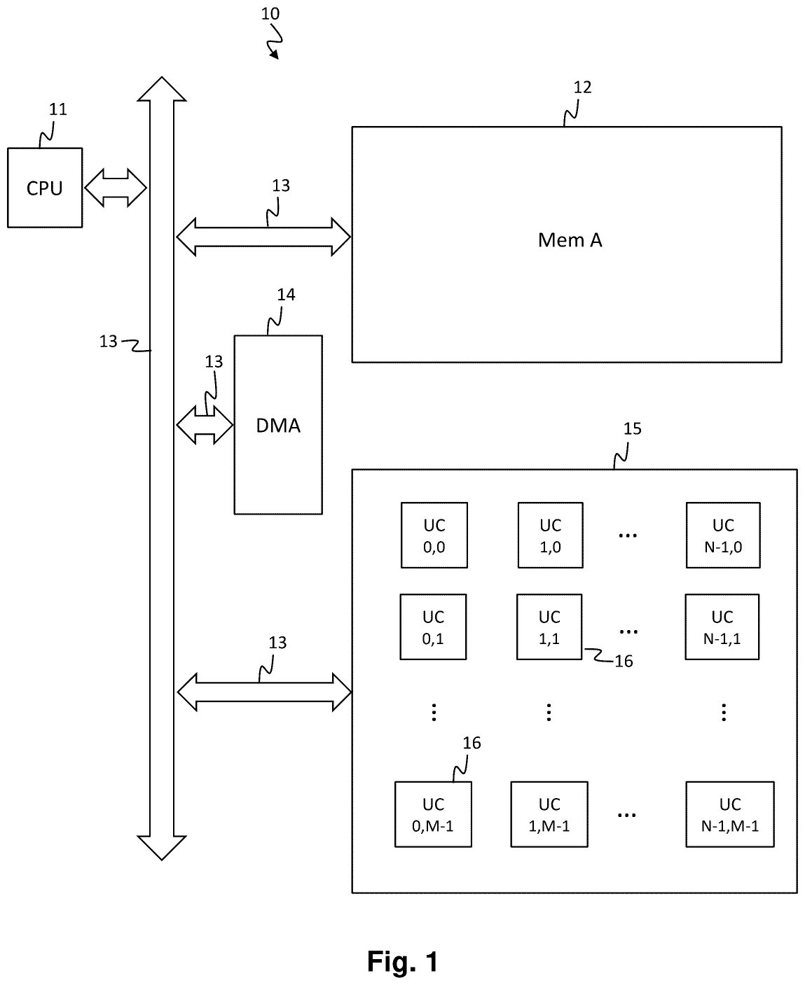

Similarly to the conventional computing system 10 described with reference to FIG. 1, the computing system 20 comprises a host processor 21, a parallel processing processor 40, a memory 30, hereinafter “memory A” (Mem A), an interconnection bus 22, and a memory access control module 50 (also referred to as DMPA in the drawings, for “Direct Memory Parallel Access”).

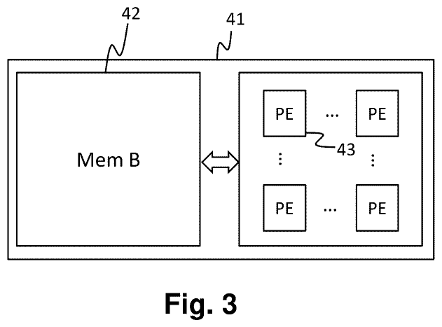

As illustrated in FIG. 3, each computing unit 41 comprises one or more elementary processors 43 (PE) and a memory 42, hereinafter “memory B” (Mem B), shared by these elementary processors 43.

The computing units 41 (UC) of the parallel processing processor 40 are arranged in the form of a matrix into N columns and M rows (N being an integer greater than or equal to two, and M an integer greater than or equal to one). In each column, the computing units 41 are ordered from a first computing unit to a last computing unit, with zero, one or more intermediate computing units between the first computing unit and the last computing unit. For an index column i (i being an index varying between 0 and N−1), the computing units are denoted UC_{i,j} (j being an index varying between 0 and M−1); the first computing unit 41 of the column corresponds to the computing unit UC_{i,0}; the last computing unit 41 of the column corresponds to the computing unit UC_{i,M-1}; the intermediate computing units correspond to the computing units UC_{i,j} with j varying between 1 and M−2). When the column comprises only one computing unit (M=1), then the first computing unit and the last computing unit of the column correspond to one and the same computing unit.

In the example considered, the memory A corresponds to the main memory of the system. This memory is generally qualified as a level 2 memory (L2 memory). The memories B of the computing units distributed in the parallel processing processor 40 are generally qualified as level 1 memories (L1 memory).

The host processor 21 (CPU) manages the general execution of the system, including the communication with the parallel processing processor 40. The parallel processing processor 40 acts as the hardware accelerator: it is specifically designed to be able to carry out intensive computing operations for executing the machine learning algorithm. In particular, the various computing units UC_{i,j} can work at the same time to optimize the performance of the system.

Conventionally, the interconnection bus 22 may make it possible to carry out data exchanges between the host processor 21, the memory 30 and the parallel processing processor 40, and also possibly with other components of the system.

The invention is based on a division of the memory A into a plurality of partitions with a column arrangement similar to that of the memories B embedded in the parallel processing processor 40 (“column symmetry” between the partitions of the memory A and the distributed memories B). This partitioning makes it possible to multiply the access interfaces to the memory and gives the opportunity to transfer at the same time with the distributed memories B.

In order to enable these transfers at the same time in the various columns, the memory A is partitioned into N partitions (as many partitions as columns of computing units). In FIG. 2, the partitions are denoted Ai, with i varying between 0 and (N−1). Each partition of the memory A is associated with a column of computing units 41. For an index column i, the computing system 20 comprises connection modules 60 ordered from a first connection module connected to the partition Ai, to a last connection module connected to the memory B of the last computing unit UC_{i,M-1}. Zero, one or more intermediate connection modules may be positioned between the first connection module and the last connection module. Each intermediate connection module is connected to the memory B of a computing unit UC_{i,j} with j varying between 0 and (M−2).

It should be noted that the connection between a connection module 60 and its associated memory partition A or memory B is a direct connection (without any intermediate component).

The connection modules 60 of an index column i may therefore be ordered with an index k varying between 0 and M: the first connection module 60, of index 0, is associated with the partition 31 of the memory A; the second connection module 60, of index 1, is associated with the first computing unit UC_{i,j} of the column; . . . ; the last connection module 60 of index M is associated with the last computing unit UC_{i,M-1} of the column. For a connection module 60 of index k, with k between 1 and (M−1), the previous connection module corresponds to the connection module of index (k−1), and the next connection module corresponds to the connection module of index (k+1).

As illustrated in FIG. 2, the first connection module (that which is associated with the partition of the memory A) has a dedicated interface link 61 with the next connection module (that which is associated with the first computing unit of the column). Each intermediate connection module has a dedicated interface link 61 on the one hand with the previous connection module and on the other hand with the next connection module. The last connection module has a dedicated interface link 61 with the previous connection module.

The memory access control module 50 is adapted to configure the connection modules 60 to carry out data transfers at the same time in at least two different columns. The memory access control module 50 may particularly be configured by the host processor 21; in an alternative embodiment, the memory access control module 50 may be configured by the parallel processing processor 40.

For example, the memory access control module 50 is adapted to configure the connection modules 60 to carry out a first data transfer, within an index column p, with p between 0 and (N−1), between the partition Aₚ and a memory B of at least one computing unit 41 of the index column p and, simultaneously with the first transfer, to carry out at least one second data transfer, within an index column q, with q between 0 and (N−1) and different from p, between the partition A_{q} and a memory B of at least one computing unit 41 of the index column q.

For each data transfer within a column, the data pass through the dedicated interface links 61 connecting the various connection modules 60 with one another, without passing through the interconnection bus 22. The dedicated interface links 61 are bidirectional, they each have an uplink and a downlink.

A data transfer within a column is a “dedicated” data transfer, i.e. a data transfer passing through dedicated connection modules and interface links. A “dedicated” data transfer is carried out via the dedicated interface links between the connection module whose associated memory (memory partition A for a first connection module of a column, or memory B for an intermediate connection module or for a last connection module of a column) is the origin of the transfer and the connection module associated with the memory which is the destination of the transfer, via the intermediate connection modules which separate them (if any).

A data transfer within a column is associated with a source address (address in the memory originating the transfer) and a destination address (address in the memory receiving the transfer) configured by the memory access control module 50.

According to a first example, a data transfer within a column may have for source the partition of the memory A and for recipient the memory B of at least one computing unit 41 of the column (this then refers to “downward” transfer). According to a second example, a data transfer within a column may have for source the memory B of a computing unit 41 of the column and for recipient the partition of the memory A (this then refers to “upward” transfer). According to a third example, a data transfer within a column may have for source the memory B of a computing unit 41 and for recipient the memory B of at least one other computing unit of the column (the transfer may then be upward or downward). According to yet another example, a data transfer within a column may have for source the memory B of a computing unit 41 and for recipients both the partition of the memory A and the memory B of at least one other computing unit of the column.

Advantageously, when a data transfer within a column has for source the partition of the memory A and for recipients the memories B of a plurality of computing units 41 of the column, the transferred data pass at most once through the connection module 60 of each computing unit 41 of the column.

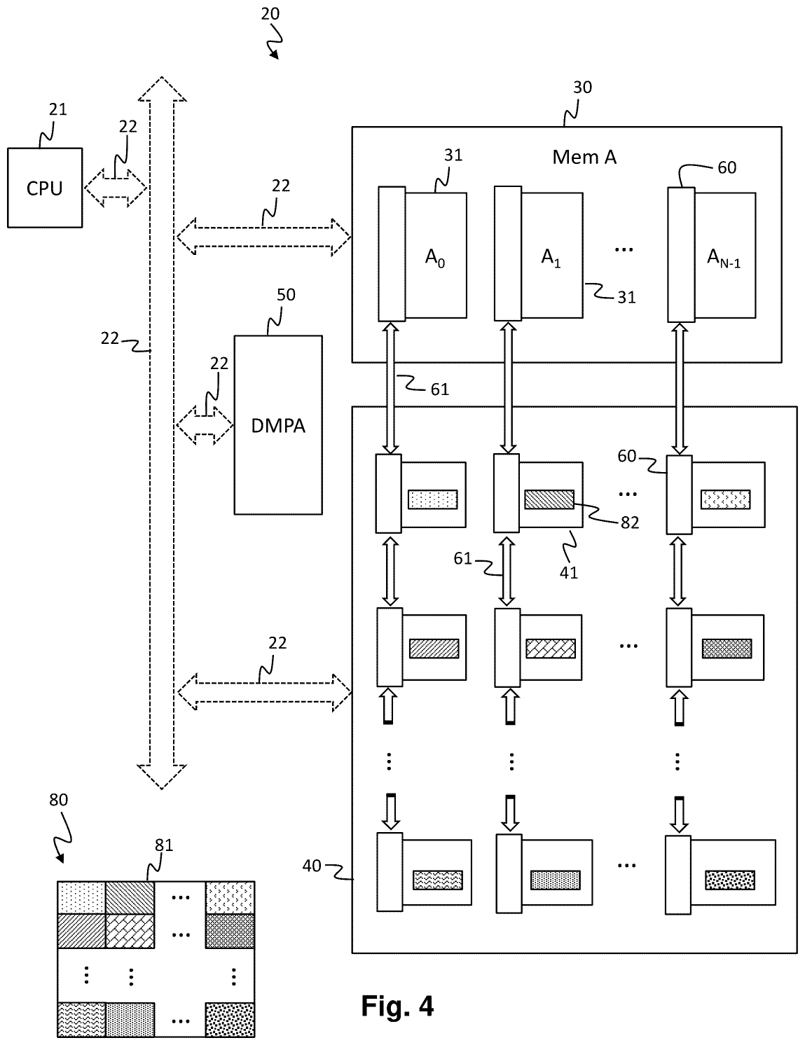

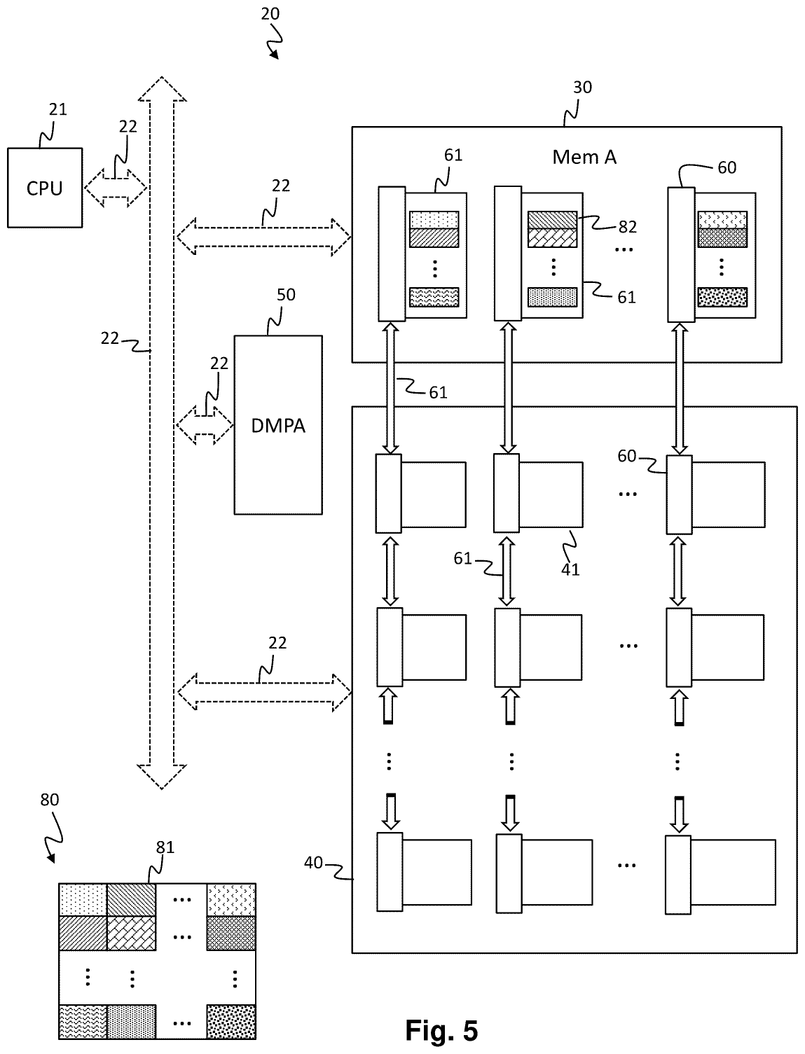

Advantageously, and as illustrated in FIGS. 4 and 5, the memory access control module 50 may be adapted to configure the connection modules 60 to carry out simultaneous data transfers involving a plurality of columns with, for each column involved, a data transfer from a region of a memory B of a computing unit 41, said region being located at a local source address identical for all the columns involved, to a region of the partition 31 located at a local destination address identical for all the columns involved.

In the example illustrated in FIGS. 4 and 5, the computing units 41 of the parallel processing processor 40 are used to process the pixels of an image 80. The image 80 is divided in the form of a matrix into as many pixel zones 81 as there are computing units 41 (the image is therefore divided into N columns and M rows). The data associated with each pixel zone 81 of the image 80 are processed by a computing unit. It is possible to move the data 82 processed by each computing unit 41 from the same row to the memory A simultaneously, by carrying out transfers at the same time in the N columns. All of the data 82 processed by the various computing units 41 of the same row are all stored at the same local address in the various partitions of the memory A. By repeating this operation M times (row by row), the set of all of the data processed by the computing units 41 of the parallel processing processor 40 can then be moved to the memory A, as illustrated in FIG. 5.

On a neural network type application, and particularly for a residual neural network, the fact of having a plurality of branches in the graph modeling the neural network involves the need to save the data at the separation of branches and to reload them subsequently during the merging of branches. The computing system 20 according to the invention makes it possible to save data from the memories B to the partitions of the memory A (in the upward direction), this at the same time for the N columns. A partition of the memory A is itself divided into a plurality of regions, each region being associated with a memory B of the column and identified by an offset.

Similarly, the loading of the data required at the moment of merging branches will be carried out at the same time on the various columns (in the downward direction). In this aim, the memory access control module 50 may be adapted to configure the connection modules 60 to carry out simultaneous data transfers involving a plurality of columns with, for each column involved, a data transfer from a region of the partition 31 located at a local source address identical for all the columns involved, to a region of a memory B of at least one computing unit 41, said region being located at a local destination address identical for all the columns involved.

The transfer rate is thus multiplied by the number of columns in the chosen arrangement. Let us assume for example that the dedicated interface links 61 have a data width of sixty-four bits. If a parallel processing processor 40 comprising twenty-four computing units 41 arranged into four columns and six rows is considered, then the transfer rate is 256 bits/cycle (4×64=256). If a parallel processing processor 40 comprising forty-eight computing units 41 arranged into eight columns and six rows is considered, then the transfer rate is 512 bits/cycle (8×64=512). If a parallel processing processor 40 comprising sixty-four computing units 41 arranged into sixteen columns and four rows is considered, then the transfer rate is 1,024 bits/cycle (16×64=1,024).

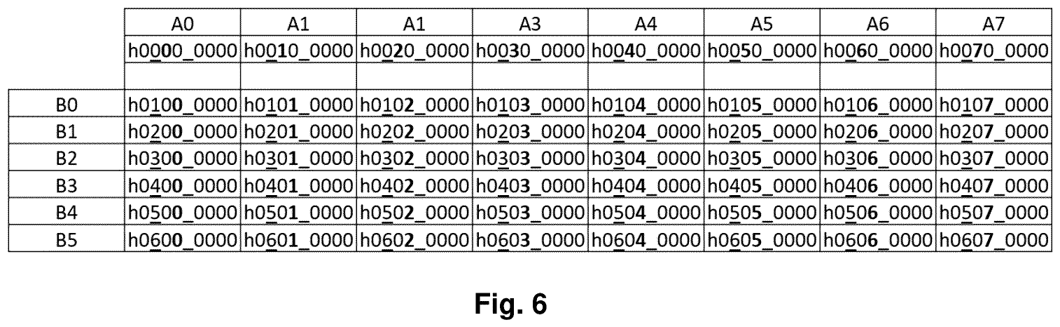

FIG. 6 illustrates one example of address mapping of the memory A for a computing system 20 with a parallel processing processor 40 comprising forty-eight computing units 41 arranged into eight columns and six rows. For each partition A₀ to A₇ associated with a column, memory regions are reserved for each of the six computing units 41 of the column (B₀, B₁, . . . , B₆). The memory addresses are shown in hexadecimal. For each address, the field formed by the sixteen low-order bits represents a local address range; the field shown in bold characters makes it possible to code the position of the column; the highlighted field makes it possible to code the position of the row.

The partitions 31 of the memory A are advantageously defined with a contiguous address mapping. This particularly makes it possible to have a unified access via the interconnection bus 22. Thus, the host processor 21 can use the memory A as a unified memory. This access from the interconnection bus 22 is particularly interesting in the case of embedded systems, for which the memory A may correspond to the main memory of the host processor 21. This main memory may contain the executable code as well as the data required for executing the host processor 21. A connection script file is generally used by the compiler in order to organize the various sections of code and of data in the memory during the creation of an executable. Specific sections (distinct from those storing the executable code of the host processor) may then be added in this script file, particularly to define sections dedicated to the data exchange between the memory A and the distributed memories B, or sections dedicated to the parameters of a neural network.

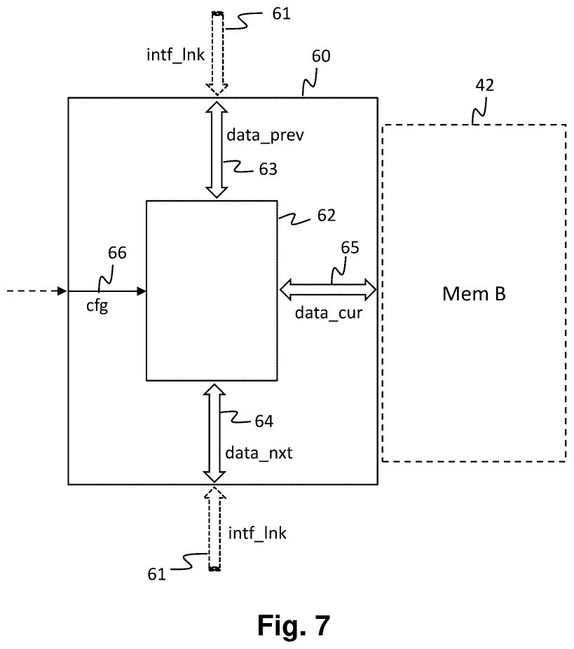

FIG. 7 schematically shows one example of embodiment of a connection module 60. As illustrated in FIG. 7, the connection module 60 comprises a routing module 62 making it possible to exchange data with another connection module 60 of the same column. A configuration link 66 (cfg link) makes it possible for the memory access control module (DMPA) 50 to configure the routing module 62 of the connection module 60. The connection module 60 comprises a bidirectional routing link 63 with the previous connection module (data_prev link), a bidirectional routing link 64 with the next connection module (data_nxt link), and a bidirectional routing link 65 with the memory to which it is connected (data_cur link, routing link with the memory of the current connection module). Each bidirectional link comprises an uplink and a downlink. The data_prev link (respectively the data_nxt link) can be connected to a dedicated interface link 61 to exchange data with the previous connection module (respectively with the next connection module).

In the example illustrated in FIG. 7, the connection module 60 is connected to the memory 42 of a computing unit 41 (memory B). According to another example (for the first connection module of the column), the connection module 60 may be connected to a partition 31 of the memory A; in this case there would be no dedicated interface link 61 connected to the data_prev routing link 63. If the connection module 60 corresponds to the last connection module of the column, then there is no dedicated interface link 61 connected to the data_nxt routing link 64.

In order to write the data coming from the previous connection module in the memory 42 associated with the current connection module 60, the data pass through the downlink of the data_prev routing link 63, then through the uplink of the data_cur routing link 65.

In order to write the data coming from the next connection module in the memory 42 associated with the current connection module 60, the data pass through the uplink of the data_nxt routing link 64, then through the uplink of the data_cur routing link 65.

In order to transmit the data read in the memory 42 associated with the current connection module 60 to the previous connection module, the data pass through the downlink of the data_cur routing link 65, then through the uplink of the data_prev routing link 63.

In order to transmit the data read in the memory 42 associated with the current connection module 60 to the next connection module, the data pass through the downlink of the data_cur routing link 65, then through the downlink of the data_nxt routing link 64.

The routing module 62 may also be configured to route data coming from the previous connection module to the next module without reading or writing in the memory 42 associated with the current connection module 60 (in this case the data pass through the downlink of the data_prev routing link 63 then through the downlink of the data_nxt routing link 64). Similarly, the routing module 62 may be configured to route data coming from the next connection module to the previous module without reading or writing in the memory 42 associated with the current connection module 60 (in this case the data pass through the uplink of the data_nxt routing link 64 then through the uplink of the data_prev routing link 63).

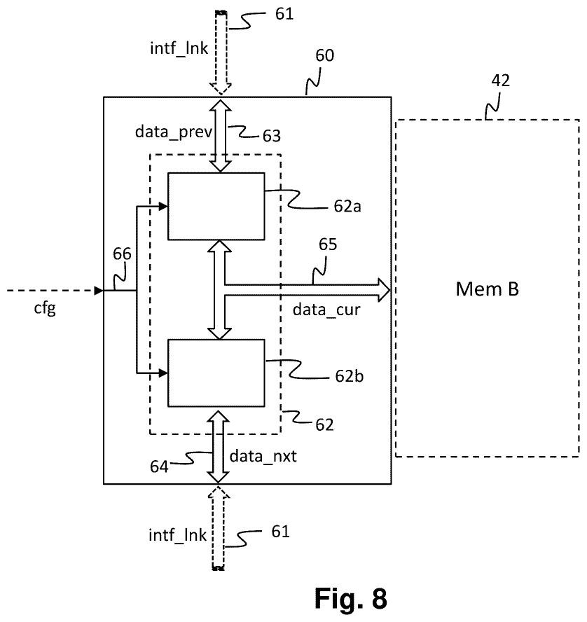

In particular embodiments, and as illustrated by way of example in FIG. 8, the routing module 62 may comprise an upper routing block 62a and a lower routing block 62b.

The upper routing block 62a may be configured in the following modes:
“Read”: for reading data in the memory 42 associated with the current connection module 60 and transmitting the data read to the previous connection module, or
“Write”: for receiving data from the previous connection module and writing the data received in the memory 42 associated with the current connection module 60, or
“Default”: for receiving data from the previous connection module and transferring the data received to the lower routing 62b of the current connection module 60.

The lower routing block 62b may be configured in the following modes:
“Read”: for reading data in the memory 42 associated with the current connection module 60 and transmitting the data read to the next connection module, or
“Write”: for receiving data from the next connection module and writing the data received in the memory 42 associated with the current connection module 60, or
“Default”: for receiving data from the next connection module and transferring the data received to the upper routing 62a of the current connection module 60.

It should be noted that, for simplification reasons, the control signals with the memory 42 (conventional control signals making it possible for example to indicate the type of access (read or write) and the targeted address) are not shown in FIGS. 7 and 8.

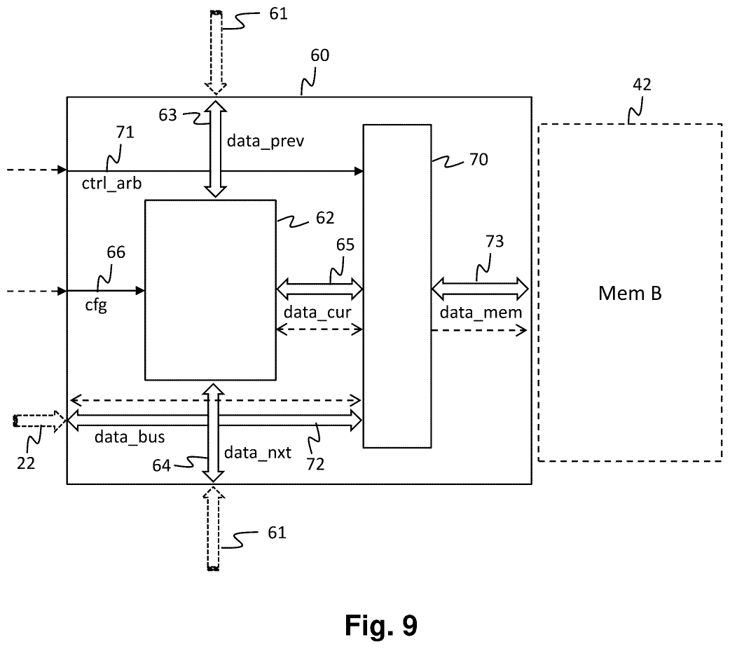

In particular embodiments, and as illustrated in FIG. 9, the connection module 60 may comprise an arbitration module 70 making it possible to manage an access priority to the memory 42 associated with the connection module 60. The priority is managed between:
a “dedicated” transfer involving a neighboring connection module 60 (previous or next connection module),
a “bus” transfer involving the interconnection bus 22.

As illustrated in FIG. 9, the arbitration module 70 may exchange (read or write) data with the interconnection bus 22 via a data_bus bidirectional routing link 72. The arbitration module 70 may exchange data with the memory associated with the connection module 60 via a data_mem bidirectional routing link 73.

The host processor 21 may indeed use the memory access control module 50 to exchange data with the memory B of a computing unit 41 of the parallel processing processor 40, by passing through the interconnection bus 22, without passing through a dedicated interface link 61 connecting two neighboring connection modules 60; which is called a “bus” transfer. In this case, the data transit over an interconnection bus 22 and over the data_bus 72 and data_mem routing links 73.

The host processor 21 may also use the memory access control module 50 to transfer data between the memory A and a memory B of at least one computing unit 41 of the parallel processing processor 40, by passing through the dedicated interface links 61 connecting the connection modules 60 with one another, without passing through the interconnection bus 22; which is called a “dedicated” transfer. In this case, the data transit over dedicated interface links 61, over data_prev 63 or data_nxt routing links 64, and over data_cur 65 and data_mem routing links 73.

In the event of competitive access to the memory, for a “dedicated” transfer over the data_cur routing link 65 and for a “bus” transfer over the data_bus routing link 72, the arbitration module 70 makes it possible to manage the access priority to the memory, so as to only authorize a single transfer at a time of the two competitive transfers (or in other words to prohibit a simultaneous access to the memory for these two competitive transfers).

As illustrated in FIG. 9, a ctrl_arb control link 71 makes it possible for the memory access control module 50 to configure the arbitration module 70. Control signals (shown by arrows in dotted lines in FIG. 9) are respectively associated with the data_cur routing link 65, with the data_bus routing link 72 and with the data_mem routing link 73. These control signals, conventionally, make it possible to indicate the type of access to the memory (read or write) and the targeted address. Furthermore, a return signal managed by the arbitration module 70 makes it possible to indicate to the routing module 62 (respectively to the interconnection bus 22) if it is authorized to access the memory associated with the connection module 60. The return signals take for example the value ‘1’ by default; the return signal associated with the data_cur routing link changes to the value ‘0’ when a “bus” transfer is in progress; the return signal associated with the data_bus routing link changes to the value ‘0’ when a “dedicated” transfer is in progress).

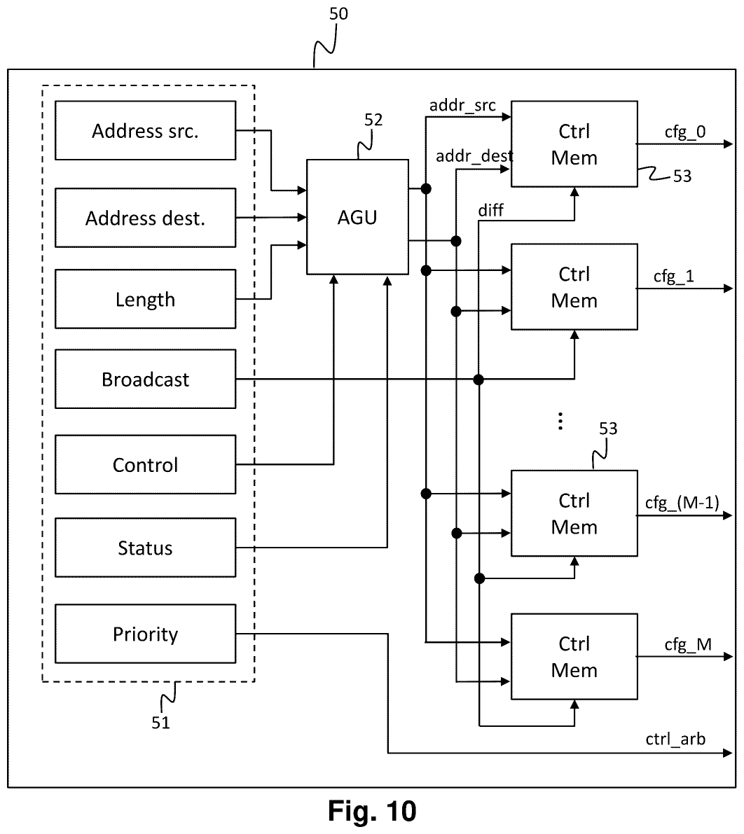

FIG. 10 schematically shows one example of embodiment of the memory access control module (DMPA) 50 of the computing system 20 described with reference to FIGS. 2, 4 and 5.

The memory access control module 50 comprises a set 51 of configuration registers, with for example:
a “Source address” register for indicating the source memory address of the transfer,
a “Dest. address” register for indicating the destination memory address of the transfer,
a “Length” register for indicating the length of the transfer (for example in number of bytes),
a “Broadcast” register for processing the case where the data must be transfered to a plurality of recipients,
a “Control” register for initiating the transfer,
a “Status” register for providing information about the transfer in progress, and particularly for indicating the end of the transfer,
a “Priority” register for managing the priority between a “bus” transfer and a “dedicated” transfer.

The memory access control module 50 also comprises an address generator unit (AGU) 52. The AGU makes it possible to compute source and destination addresses throughout the entire duration of a transfer.

In the example considered, the memory access control module 50 also comprises a control module 53 (Ctrl Mem) for each row of connection modules 60. Each control module 53 is adapted to configure identically all the connection modules 60 of the same row (that is to say all the connection modules 60 having the same order rank in the various columns).

It should be noted that, in an alternative embodiment, it may be considered to configure the connection modules 60 of the same row differently; however to achieve this a plurality of control modules should be implemented for the same row (for example one control module for each connection module 60).

Each control module 53 takes as input a source address (addr_src signal), a destination address (addr_dest signal) and broadcasting options (diff signal), and provides as output a configuration (cfg signal) intended for each connection module 60.

As seen above, the ctrl_arb control signal makes it possible to configure the arbitration module 70.

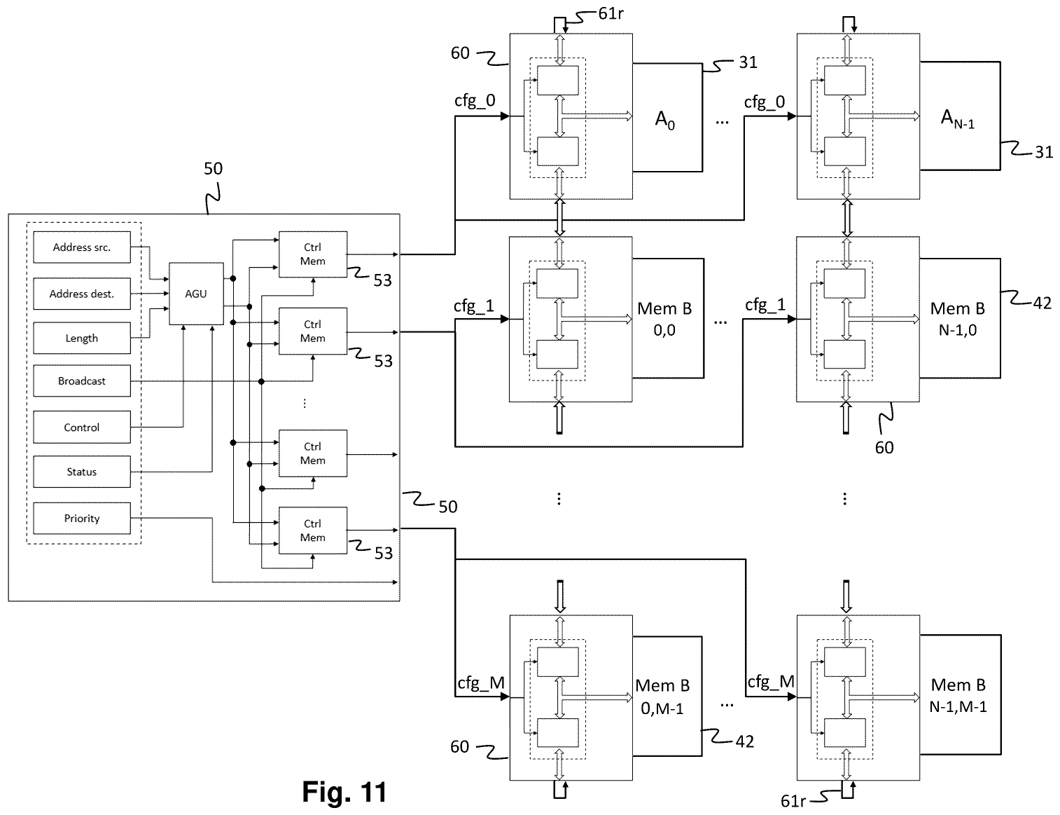

FIG. 11 schematically illustrates the configuration of various connection modules 60 by the control modules 53 of the DMPA 50.

As illustrated in FIG. 11, the cfg_0 signal corresponds to the configuration of the connection modules 60 associated with the partitions 31 of the memory A; the cfg_1 signal corresponds to the configuration of the connection modules 60 associated with the memory B of the first computing units of the various columns; the cfg_M signal corresponds to the configuration of the connection modules 60 associated with the memory B of the last computing units of the various columns. The propagation of the ctrl_arb signal to the various connection modules 60 is not shown in FIG. 11, in the interest of clarity.

Advantageously, in the example considered, the connection modules 60 are all implemented identically; the control modules 53 are also all implemented identically.

As illustrated in FIG. 11, it can be considered to use a loopback link 61r to connect the uplink and the downlink of the data_prev routing link of the first connection module 60 of each column, and to connect the downlink and the uplink of the data_nxt routing link of the last connection module 60 of each column. Such provisions make it possible to manage certain particular scenarios for broadcasting data from the memory B of a computing unit 41 once to the memory B of at least one other computing unit 41 and to the memory A.

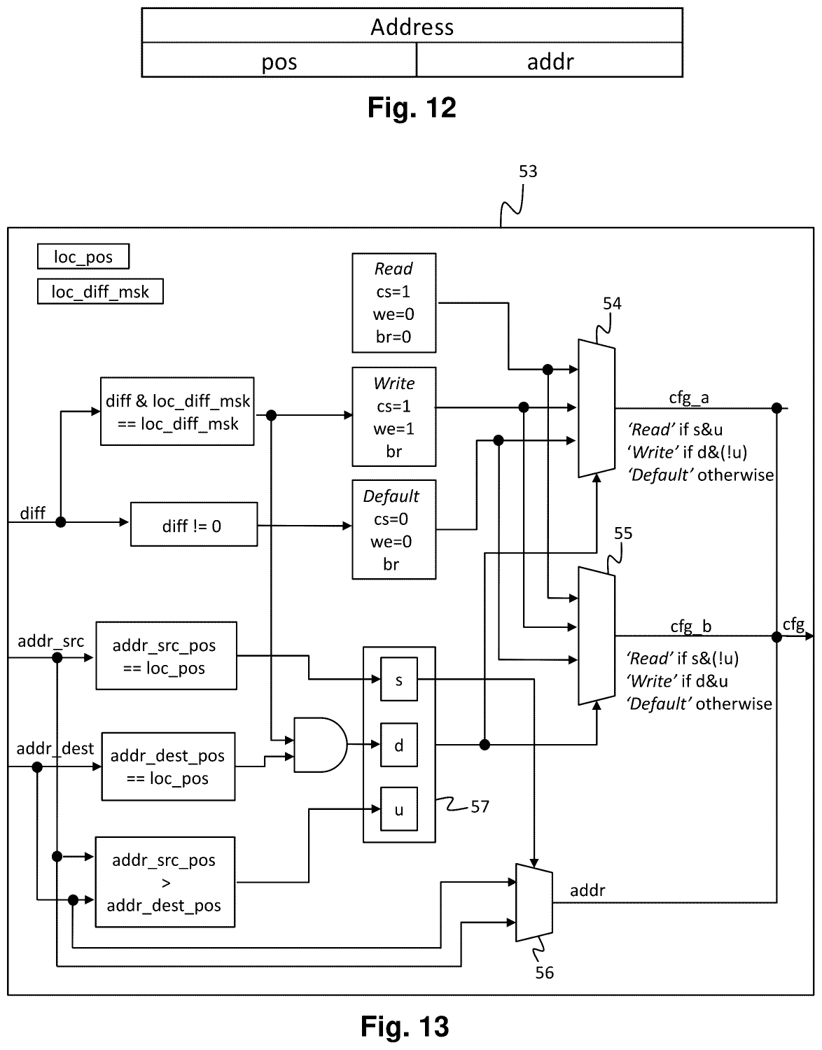

FIG. 12 schematically shows the fields forming a source address or a destination address as input of a control module 53 (address provided via the addr_src signal or the addr_dest signal). The address particularly includes a “pos” field indicating the position of the targeted memory, and an “addr” field indicating the local memory address in the targeted memory. In the example considered, the addr field is coded by low-order bits; the pos field is coded by high-order bits. In the example considered, all the connection modules 60 of the same row are configured identically (or in other words all the connection modules 60 positioned at the same position in a column are configured identically); therefore the pos field simply needs to indicate the position in the column. For example, the pos field takes the value ‘0’ to indicate the partition 31 of the memory A associated with the column; the pos field takes the value ‘1’ to indicate the memory B of the first computing unit 41 of the column; . . . ; the pos field takes the value ‘M’ to indicate the memory B of the last computing unit 41 of the column.

FIG. 13 schematically shows one example of embodiment of a control module 53 of the DMPA 50. Each control module 53 stores its position via a “loc_pos” register. As illustrated in FIG. 13, various logic blocs make it possible to determine, from addr_src and addr_dest signals and from the loc_pos register, if the memory associated with a connection module 60 configured by the control module 53 is a source or a destination for the transfer, as well as the direction (upward or downward) of the transfer.

In particular, if addr_src_pos (value of the addr_src pos field) is equal to loc_pos, then the memory associated with a connection module 60 configured by the control module 53 is a source for the transfer considered (a read will need to be carried out in this memory); the s signal is then activated (it is set at the value ‘1’) in the logic block 57 (otherwise it is set at the value ‘0’).

If addr_dest_pos (value of the addr_dest pos field) is equal to loc_pos, then the memory associated with a connection module 60 configured by the control module 53 is a destination for the transfer considered (a write will need to be carried out in this memory); the d signal is then set at the value ‘1’ in the logic block 57 (otherwise it is set at the value ‘0’).

If addr_src_pos is strictly greater than addr_dest_pos, then this concerns a downward transfer; the u signal is then set at ‘0’ in the logic block 57. Otherwise, this concerns an upward transfer; the u signal is then set at ‘1’ in the logic block 57.

A routing module 62 can then be configured as a function of the s, d and u signals. More particularly, the upper routing block 62a is configured (cfg_a signal as output of the multiplexer 54 in FIG. 13):
in “Read” mode if the s and u signals are both activated (that is to say they both take the value ‘1’),
in “Write” mode if the d signal is activated and the u signal is deactivated,
in “Default” mode otherwise.

The lower routing block 62b is configured (cfg_b signal as output of the multiplexer 55 in FIG. 13):
in “Read” mode if the s signal is activated and the u signal is deactivated,
in “Write” mode if the d and u signals are both activated,
in “Default” mode otherwise.

As illustrated in FIG. 13, a configuration of an upper or lower routing block comprises a cs (“chip select”) control signal and a we (“write enable”) control signal. In “Read” mode the cs signal is activated and the we signal is deactivated; in “Write” mode the cs signal and the we signal are both activated; in “Default” mode, the cs signal and the we signal are both deactivated. The configuration also includes an addr signal indicating the targeted local address for the read (if the s signal is activated, this then concerns the addr_src addr field) or for the read (if the d signal is activated, this then concerns the addr_dest addr field).

When a data transfer requires data to be written in the memories associated with a plurality of connection modules 60 of the same column (broadcasting of data to a plurality of recipients within the same column), the diff signal includes information about the connection modules 60 involved by these multiple writes. For example, the diff signal provides coded information in the form of a bit field comprising as many bits as there are connection modules 60 per column. Each bit of the bit field is respectively associated with a connection module 60 in the column (for example the first low-order bit corresponds to the connection module 60 associated with the partition 31 of the memory A, the second low-order bit corresponds to the first connection module 60 of a column, . . . , the (M+1)^{th} low-order bit corresponds to the last connection module 60 of a column). The value of a bit of the bit field takes the value ‘1’ if the corresponding connection module 60 is involved by a multiple write (that is to say if it is part of the recipients for the transfer considered). Otherwise, the bit takes the value ‘0’.

As illustrated in FIG. 13, a loc_diff_msk mask may be stored in a register of the control module 53 to verify if the connection modules 60 that they configure are involved by a multiple write (for example by bit-by-bit comparison of diff and loc_diff_msk). If this is the case, then the d signal is activated.

In addition to the cs and we signals, the configuration of an upper 62a or lower routing block 62b comprises a br (“broadcast”) control signal. This signal is always deactivated (it takes the value ‘0’) in “Read” mode. This signal is activated (it takes the value ‘1’) in “Write” mode or in “Default” mode when the diff signal indicates that the transfer involves a plurality of recipients.

Let us consider, a first example of transfer for a case where M=2, that is to say two computing units 41 per column (that is to say three connection modules 60 per column). For this first example of transfer:
for each index column i, a parallel transfer of data from the computing unit UC_{i,1} to the partition Aᵢ must be carried out;
addr_src=h0002_0100 (pos=2 and addr=h0100), this means that for each computing unit UC_{i,1}, the data must be read in a region at the local address h0100 of the memory B of the computing unit;
addr_dest=h0000_0000 (pos=0 and addr=h0000), this means that in each partition, the data must be written in a region located at the local address h0000 of the partition,
diff=b000, this means that there is no broadcasting of the data to a plurality of recipients (in each column the partition Aᵢ is the only recipient).

In these conditions, in each column, the upper routing block of the last connection module (third connection module) is configured in the “Read” mode, the lower and upper routing blocks of the intermediate connection module (second connection module) are configured in the “Default” mode, and the lower routing block of the first connection module is configured in the “Write” mode. The upper routing module of the first connection module and the lower routing module of the last connection module are configured in the “Default” mode.

Let us consider, a second example of transfer for a case with M=2, wherein:
for each index column i, a parallel transfer of data from the partition Aᵢ to the two computing units UC_{i,0} and UC_{i,1} of the column must be carried out,
addr_src=h0000_0100 (pos=0 and addr=h0100), this means that for each partition, the data to be transfered must be read in a region at the local address h0100 of the partition,
addr_dest=h0001_0050 (pos=1 and addr=h0050), this means that in each column, the data must be written in a memory region located at the local address h0050 of the memory B of the first computing unit,
diff=b110, this means that in each column the data must be broadcast to a plurality of recipients, namely both computing units UC_{i,0} and UC_{i,1} of the column.

In these conditions, in each column, the lower routing block of the first connection module (third connection module) is configured in the “Read” mode, the upper routing block of the second intermediate connection module is configured in the “Write” mode, the lower routing block of the second connection module is configured in the “Default” mode, the upper routing block of the third connection module is configured in the “Write” mode. The upper routing module of the first connection module and the lower routing module of the last connection module are configured in the “Default” mode.

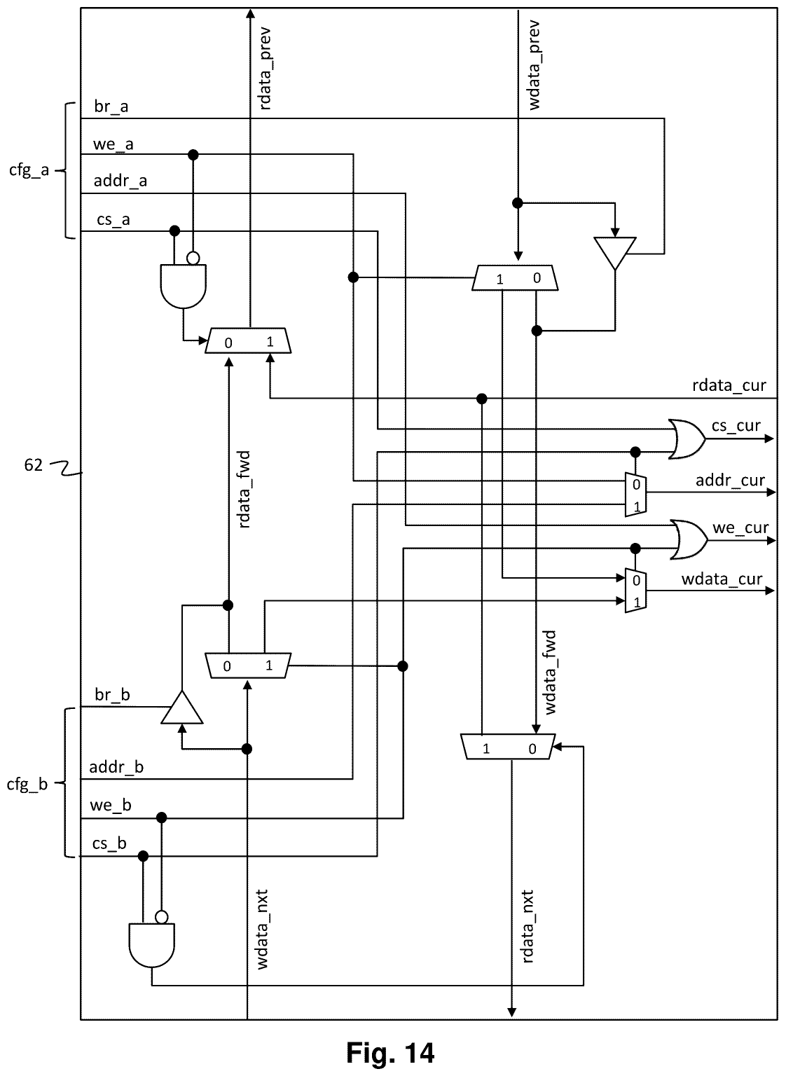

FIG. 14 schematically shows one example of embodiment of a routing module 62. An upper routing block (top portion of the routing module 62 in the figure) is configured by a control module 53 of the DMPA 50 via the cfg_a signal; a lower routing block (lower portion of the routing module 62 in the figure) is configured by the control module 53 via the cfg_b signal. The control signals relating to the upper routing block are named with the “_a” suffix (cs_a, addr_a, we_a and br_a), whereas the control signals relating to the lower routing block are named with the “_b” suffix (cs_b, addr_b, we_b and br_b). With reference to FIG. 9, the rdata_prev and wdata_prev links respectively correspond to the uplink and to the downlink of the data_prev routing link 63; the wdata_nxt and rdata_nxt links respectively correspond to the uplink and to the downlink of the data_nxt routing link 64; the wdata_cur and rdata_cur links respectively correspond to the uplink and to the downlink of the data_cur routing link 65.

When the upper routing block is configured in “Write” mode, the data arriving on the wdata_prev link are routed to the wdata_cur link, and the cs_cur, we_cur and addr_cur control signals respectively correspond to the cs_a, we_a and addr_a control signals.

When the upper routing block is configured in “Read” mode, the cs_cur, we_cur and addr_cur control signals respectively correspond to the cs_a, we_a and addr_a control signals, and the data read in the memory associated with the routing module 62 are routed from the rdata_cur link to the rdata_prev link.

When the upper routing block is configured in “Default” mode, if a broadcasting must take place (in this the br_b control signal is activated), then the data arriving on the rdata_fwd link (coming from the next connection module) are routed to the rdata_prev link.

A similar operation takes place at the lower routing block. When the lower routing block is configured in “Write” mode, the data arriving on the wdata_nxt link are routed to the wdata_cur link, and the cs_cur, we_cur and addr_cur control signals respectively correspond to the cs_b, we_b and addr_b control signals.

When the lower routing block is configured in “Read” mode, the cs_cur, we_cur and addr_cur control signals respectively correspond to the cs_b, we_b and addr_b control signals, and the data read in the memory associated with the routing module 62 are routed from the rdata_cur link to the rdata_nxt link.

When the lower routing block is configured in “Default” mode, if a broadcasting must take place (in this the br_a control signal is activated), then the data arriving on the wdata_fwd link (coming from the previous connection module) are routed to the rdata_nxt link.

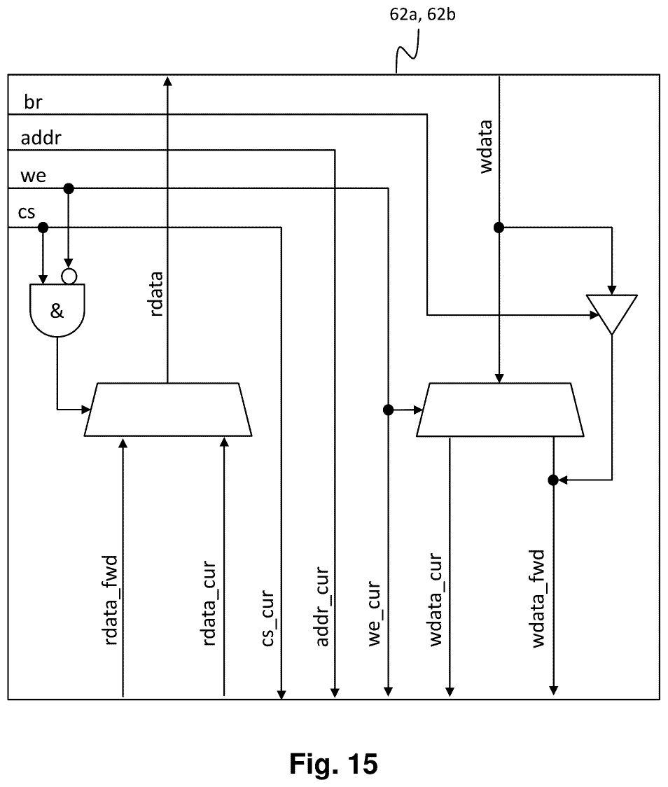

FIGS. 15 to 20 correspond to a second embodiment of a routing module 62.

FIG. 15 schematically shows one example of embodiment of an upper routing block 62a or of a lower routing block 62b for this second embodiment (the upper routing block 62a and the lower routing block 62b are both implemented identically). The rdata and wdata signals respectively correspond to the rdata_prev and wdata_prev signals in the case of an upper routing block. The rdata and wdata signals respectively correspond to the rdata_nxt and wdata_nxt signals in the case of a lower routing block.

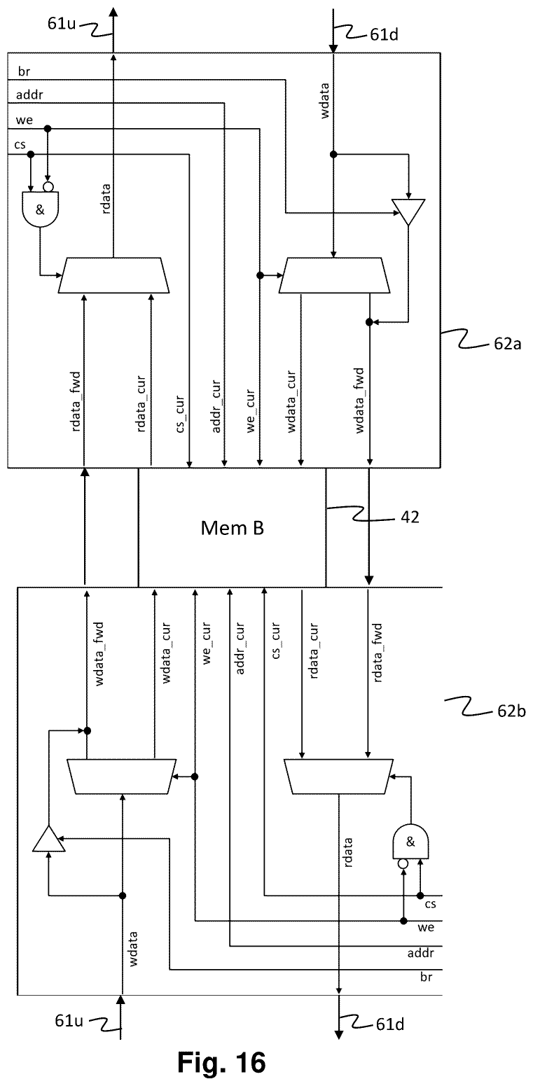

FIG. 16 shows the embodiment of an intermediate connection module for a memory B of a computing unit 41 by connecting an upper routing block 62a and a lower routing block 62b to a memory B of a computing unit 41. The reference 61u (respectively 61d) corresponds to an uplink (respectively downlink) of a dedicated interface link 61 with a neighboring connection module.

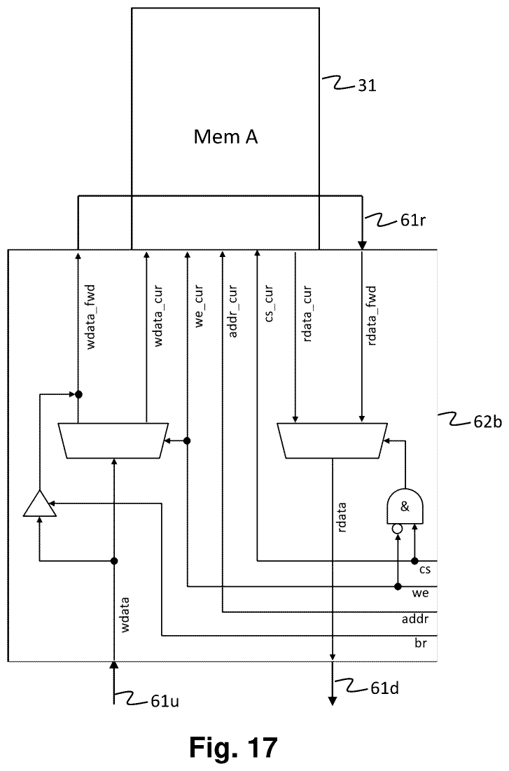

FIG. 17 shows the embodiment of a first connection module (at the top of the column) by connecting a lower routing block 62b to a partition 31 of the memory A.

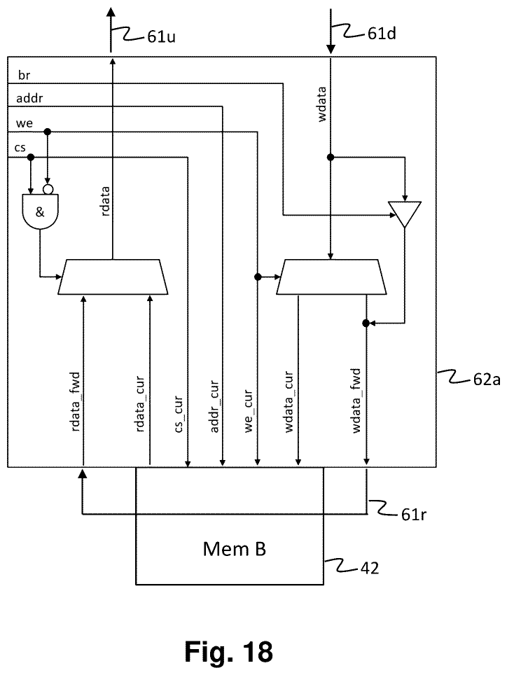

FIG. 18 shows the embodiment of a last connection module (at the bottom of the column) by connecting an upper routing block 62b to the memory B of the last computing unit 41 of the column.

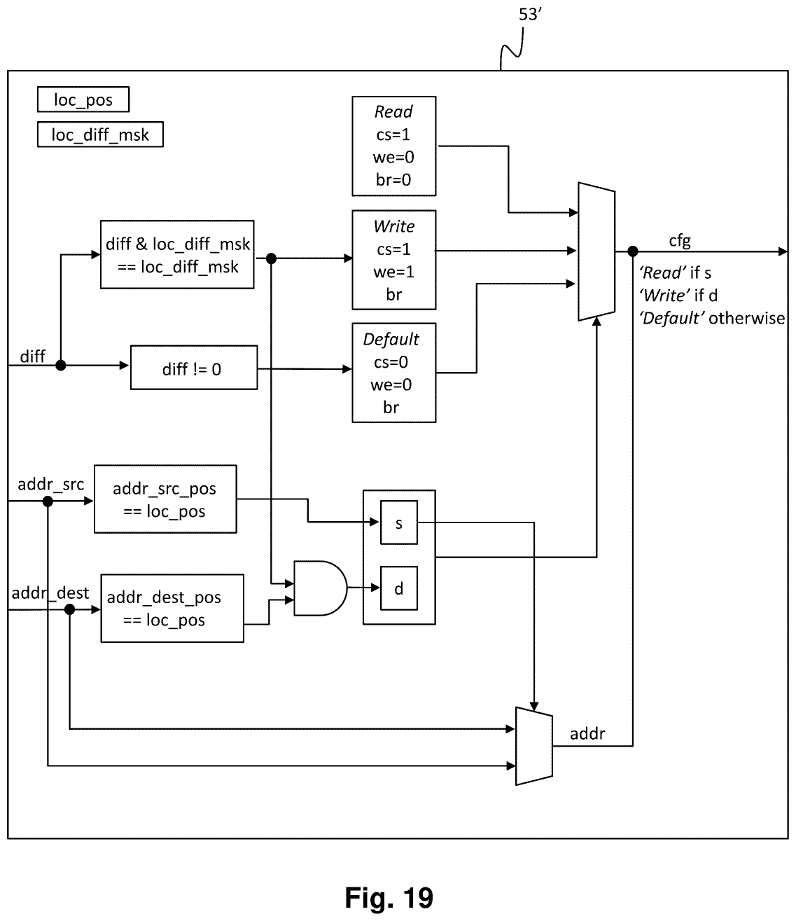

In this second embodiment, the connection modules at the top and at the bottom of the column comprise only one routing block (as opposed to the intermediate connection modules that comprise two thereof). Therefore, it is possible to simplify the control module 53′ that configures the connection modules at the top or at the bottom of the column, as illustrated in FIG. 19.

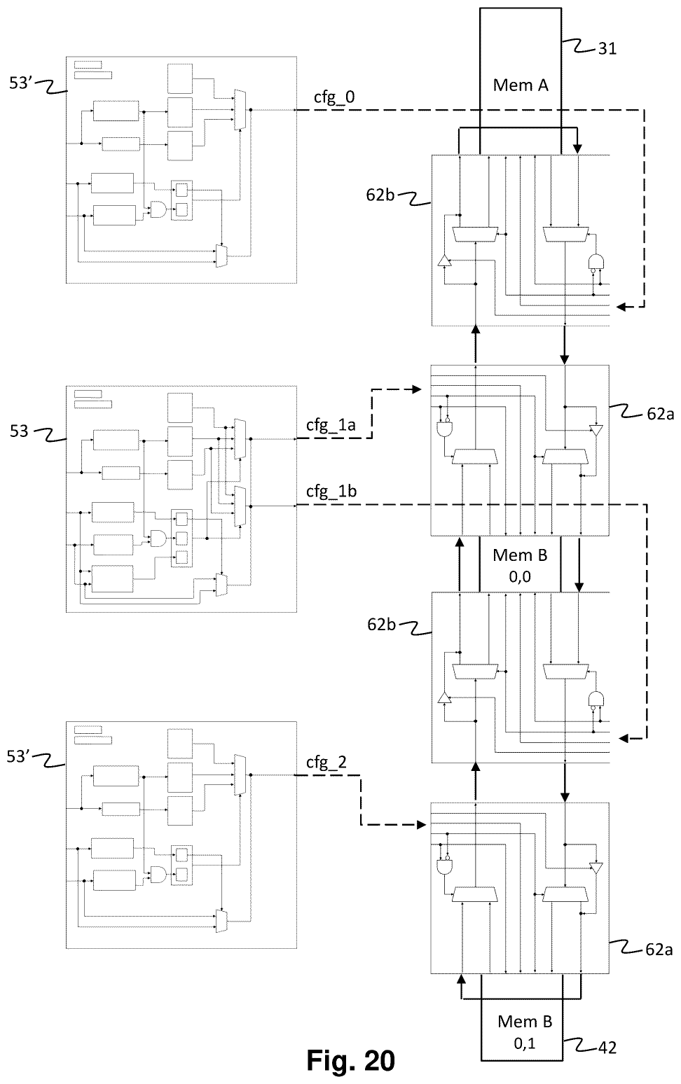

FIG. 20 illustrates the configuration of three connection modules of a column according to the second embodiment described above.

1. A computing system comprising a memory, referred to as “memory A”, a memory access control module, and a parallel processing processor comprising a plurality of computing units, each computing unit comprising one or more elementary processors and a memory, referred to as “memory B”, shared by said elementary processors,
the computing units of the parallel processing processor are arranged into a plurality of columns and, in each column, the computing units are ordered from a first computing unit to a last computing unit, with zero, one or more intermediate computing units between the first computing unit and the last computing unit, the first computing unit corresponding to the last computing unit when the column comprises only one computing unit;
the computing system is characterized in that the memory A is partitioned so as to associate a partition of the memory A with each column of computing units and, for each column:
the computing system comprises connection modules ordered from a first connection module connected to the partition of the memory A, to a last connection module connected to the memory B of the last computing unit, with zero, one or more intermediate connection modules between the first connection module and the last connection module, each intermediate connection module being connected to the memory B of a computing unit,
the first connection module has a dedicated interface link with the next connection module, each intermediate connection module has a dedicated interface link on the one hand with the previous connection module and on the other hand with the next connection module, the last connection module has a dedicated interface link with the previous connection module;
the memory access control module is adapted to configure the connection modules to carry out a first data transfer, for a first column, between the partition of the memory A associated with said first column and a memory B of at least one computing unit of said first column and, simultaneously with the first transfer, to carry out at least one second data transfer, for a second column, between the partition of the memory A associated with said second column and a memory B of at least one computing unit of said second column, the first and second data transfers being carried out via dedicated interface links (61) connecting the connection modules (60) one with another.

2. The computing system according to claim 1, wherein the first data transfer makes it possible to transfer data from the partition of the memory A associated with the first column to the memories B of a plurality of different computing units of the first column, by passing at most once through the connection module of each computing unit of the first column.

3. The computing system according to claim 1, wherein the memory access control module is adapted to configure the connection modules to carry out a data transfer, for at least one column, from a memory B of a computing unit of said column to a memory B of at least one other computing unit of said column.

4. The computing system according to claim 1, wherein the memory access control module is adapted to configure the connection modules to carry out simultaneous data transfers involving a plurality of columns with, for each column involved, a data transfer from a region of the partition located at a local source address identical for all the columns involved, to a region of a memory B of at least one computing unit, said region being located at a local destination address identical for all the columns involved.

5. The computing system according to claim 1, wherein the memory access control module is adapted to configure the connection modules to carry out simultaneous data transfers involving a plurality of columns with, for each column involved, a data transfer from a region of a memory B of a computing unit, said region being located at a local source address identical for all the columns involved, to a region of the partition located at a local destination address identical for all the columns involved.

6. The computing system according to claim 1, wherein each intermediate connection module comprises an upper routing block and a lower routing block,
the upper routing block can be configured in the following modes:
“Read”: for reading data in the memory B to which the intermediate connection module is connected and transmitting the data read to the previous connection module, or
“Write”: for receiving data from the previous connection module and writing the data received in the memory B to which the intermediate connection module is connected, or
“Default”: for receiving data from the previous connection module and transferring the data received to the lower routing block of the intermediate connection module, the lower routing block can be configured in the following modes:
“Read”: for reading data in the memory B to which the intermediate connection module is connected and transmitting the data read to the next connection module, or
“Write”: for receiving data from the next connection module and writing the data received in the memory B to which the intermediate connection module is connected, or
“Default”: for receiving data from the next connection module and transferring the data received to the upper routing block of the intermediate connection module.

7. The computing system according to claim 1, wherein:
the first connection module comprises a lower routing block that can be configured in the following modes:
“Read”: for reading data in the memory A and transmitting the data read to the next connection module,
“Write”: for receiving data from the next connection module and writing the data received in the memory A;
the last connection module comprises an upper routing block that can be configured in the following modes:
“Read”: for reading data in the memory B of the last connection module and transmitting the data read to the previous connection module,
“Write”: for receiving data from the previous connection module and writing the data received in the memory B of the last connection module.

8. The computing system according to claim 1 wherein the memory access control module comprises at least two control modules, each control module being adapted to configure identically all the connection modules having the same order rank in the various columns.

9. The computing system according to claim 8 wherein the connection modules are all implemented identically, and the control modules are all implemented identically.

10. The computing system according to claim 1 comprising a host processor and an interconnection bus, the partitions of the memory A being defined with a contiguous address mapping, the memory A comprising program code instructions to configure the host processor, the program code instructions being stored in a region of the memory A distinct from the partitions.

11. The computing system according to claim 1 comprising a host processor and an interconnection bus,
the host processor being adapted to configure the memory access control module to exchange data with the memory A or with a memory B of at least one computing unit of the parallel processing processor, by passing through the interconnection bus, without passing through a dedicated interface link connecting two neighboring connection modules,
each connection module comprises an arbitration module for managing an access priority to the memory to which the connection module is connected, between:
a “dedicated” transfer involving a neighboring connection module,
a “bus” transfer involving the interconnection bus.
